(19) United States
(12) Patent Application Publication
(10) Pub. No.: US 2013/0268107 A1
(43) Pub. Date: Oct. 10, 2013

(54) SURFACE ANALYSIS FOR DETECTING CLOSED HOLES AND METHOD FOR REOPENING

(71) Applicants: Georg Bostanjoglo, Berlin (DE); Torsten Melzer-Jokisch, Neuenhagen bei Berlin (DE); Andreas Oppert, Falkensee (DE); Dimitrios Thomaidis, Berlin (DE)

(72) Inventors: Georg Bostanjoglo, Berlin (DE); Torsten Melzer-Jokisch, Neuenhagen bei Berlin (DE); Andreas Oppert, Falkensee (DE); Dimitrios Thomaidis, Berlin (DE)

(21) Appl. No.: 13/696,871

(22) PCT Filed: May 9, 2011
(86) PCT No.: PCT/EP2011/057434

§ 371 Date: Jan. 8, 2013

(30) Foreign Application Priority Data
May 12, 2010 (EP) 10005051.7

(51) Int. Cl. G01B 21/16

(52) U.S. Cl. CPC G01B 21/16
USPC 700/166; 702/150

(57) ABSTRACT

By means of laser triangulation measurements of an uncoated and a coated component having holes, the exact positions of the holes can be detected for reopening after coating. A method for the surface analysis of at least partially closed holes which are to be opened is provided. A process for reopening coated holes is also provided.

### CROSS REFERENCE TO RELATED APPLICATIONS

This application is the US National Stage of International Application No. PCT/EP2011/057434, filed May 9, 2011 and claims the benefit thereof. The International Application claims the benefits of European Patent Office application No. 10005051.7 EP filed May 12, 2010. All of the applications are incorporated by reference herein in their entirety.

### FIELD OF INVENTION

The invention relates to a process for surface analysis for detecting closed holes and to a process for reopening.

### BACKGROUND OF INVENTION

During the repair of turbine blades or vanes, the worn ceramic protective layer has to be removed and, after restoration, reapplied. In this case, the cooling-air holes which are present are partially or completely closed during the coating process. The position and orientation of the borehole axes of the cooling-air holes cannot be determined or can only be partially determined. To date, the holes have been identified by finding slight depressions in the ceramic layer and/or relatively small openings, and opened with the aid of a manual process. A reliable, controllable system is not available.

### SUMMARY OF INVENTION

Therefore, it is an object of the invention to solve the problem mentioned above.

The object is achieved by a process as claimed in the claims and by a process for reopening as claimed in the claims.

### BRIEF DESCRIPTION OF THE DRAWINGS

The dependent claims list further advantageous measures which can be combined with one another, as desired, in order to obtain further advantages.

FIGS. 1-5 schematically show the course of the process,

FIG. 6 shows a gas turbine,

FIG. 7 shows a turbine blade or vane,

FIG. 8 shows a combustion chamber, and

FIG. 9 shows a list of superalloys.

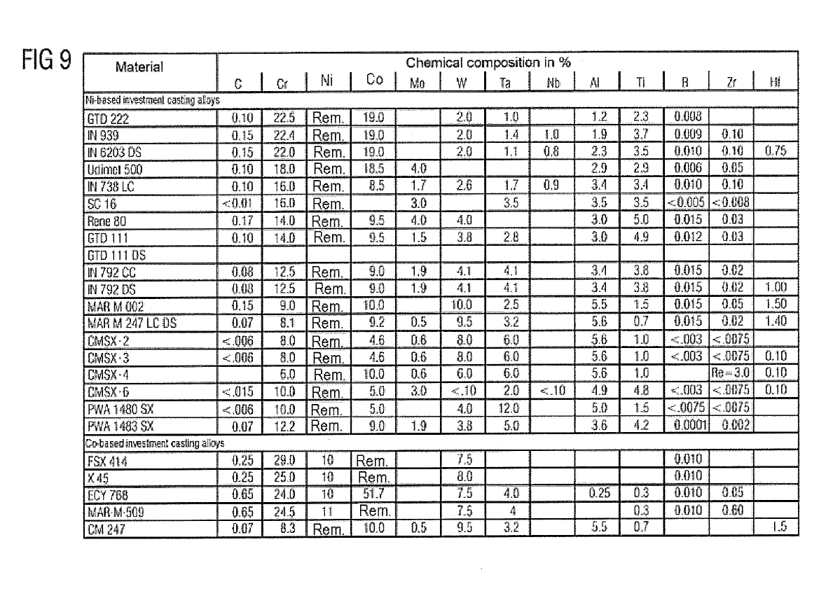

The description and the figures represent merely exemplary embodiments of the invention.

### DETAILED DESCRIPTION OF INVENTION

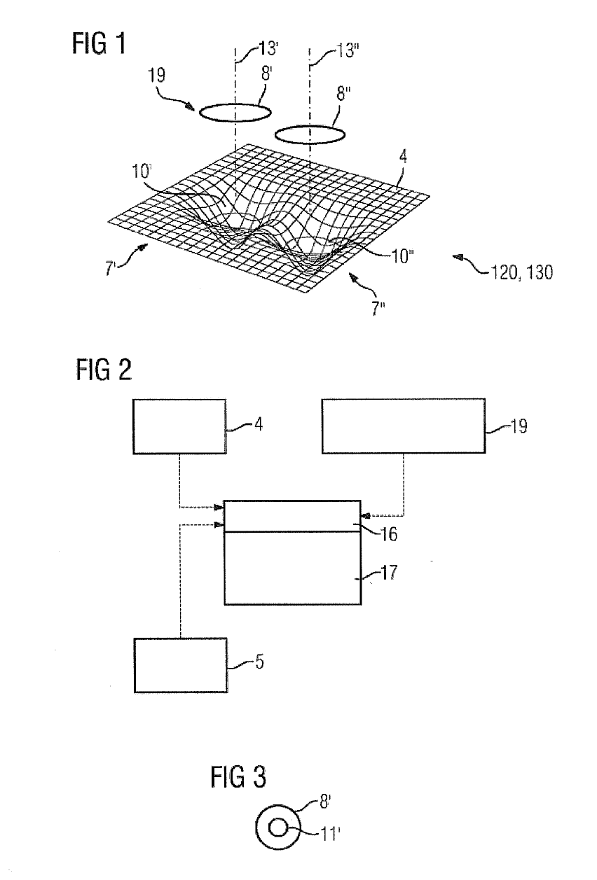

FIG. 1 shows a coating model 4 with determined geometrical data of two holes with a coating (not shown).

FIG. 1 also shows part of a mask model 19 with information relating to the position of at least one uncoated hole 7′, 7″ and to the orientation 13′, 13″ of the hole 7′, 7″.

The three-dimensional mask model 19 can also be determined by measuring the uncoated component 120, 130.

The surface of curved areas can be determined, preferably by means of laser triangulation measurement processes, in an acceptable resolution and in a very short time in a plurality of dimensions.

The blade or vane 120, 130, here as an exemplary component, is scanned in the uncoated state at the relevant locations or in its entirety in order to define the position of the holes 7′, 7″, . . . and/or in order to define the location of the axes of the holes 7′, 7″, . . . These data are later used in the computation unit 16 as a mask model 19 (FIGS. 1, 2).

Similarly, known geometrical data of the component 120, 130 can be used as the mask model 19, these being known in advance for example from the manufacturing stage.

In any event, the hole axis and the hole angle (orientation of the hole) must be present in a data record (19 in FIG. 2).

FIG. 2 shows that the computation unit 16 receives data of a mask model 19 or known geometrical data 5.

This is followed by coating of the component 120, 130. After this, the coated component 120, 130 is measured again, in particular by means of laser triangulation, as a result of which a coating model 4 is formed.

In combination with a previously determined orientation of the hole 7′, 7″ or the holes 7′, 7″, it is possible to exactly indicate the position and orientation of holes in the coated/closed state.

Here, an iterative comparison 17 (fit) of the two models 4, 19 (smallest total deviation) is carried out.

In this case, the border 11′, 11″ of a trough 10′, 10″ of an at least partially closed hole 7′, 7″ and the border 8′, 8″, . . . of an uncoated hole 7′, 7″ are used to determine the center of the hole and the location of the axis (orientation 13) of the unclosed hole 7′, 7″, . . . . The border 11′, 11″ of the trough 10′, 10″ is thus compared with the border 8′, 8″ of the hole 7′, 7″(FIG. 3) in order to determine the position of the hole 7′, 7″. In this case, depending on the coating, the border 11′, 11″ of the trough 10′, whether it is small or large, has to have a certain orientation in the border 8′, 8″, here for example concentric (FIG. 3). Here, the hole 7′, 7″ has been coated uniformly. The concentricity of the circles 8′, 11″ is lost, if the component is warped during the coating, within the hole 7′, 7″.

If there are a plurality of holes (FIG. 4), the best fit (total deviation) is determined iteratively over all the holes 7′, 7″. Here, the data relating to the borders 8′, 8″, . . . of the troughs and the borders of the holes 7′, 7″, . . . are compared together with one another. Only in this way is it possible for the holes to be reopened. With the aid of a computer, the midpoint of a hole 7′, 7″ can then be calculated and a machining program for reopening can be generated, which makes it possible to remove the “coat down” from the hole.

In addition to the computer-aided determination of positional and angular data for holes 7′, 7″ underneath a coating, the essential advantage here is primarily the exact position of the holes 7′, 7″ for each individual blade or vane and in each state of production. At present, it is only possible to predict the warpage of a blade or vane 120, 130 during the coating using empirically determined approaches. The method used here can check this prediction and determine an exact position (step 17 in FIG. 2) which shows a new position of the extents 9′, 9″ (shown by dashed lines) of the holes 7′,

Therefore, the thus determined extents 9′, 9″, . . . can be used as a basis in a machining program; these may deviate from the extents or the position 8′, 8″, 8″' of the hole 7′, 7″ before the coating (FIG. 5) because they have shifted, for example as a result of warpage.

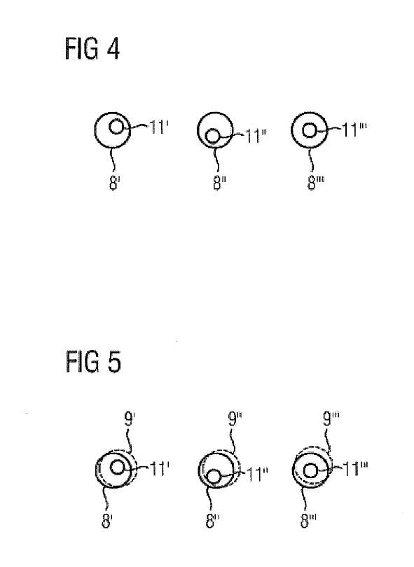

FIG. 6 shows, by way of example, a partial longitudinal section through a gas turbine 100.

In the interior, the gas turbine 100 has a rotor 103 with a shaft which is mounted such that it can rotate about an axis of rotation 102 and is also referred to as the turbine rotor.

An intake housing 104, a compressor 105, a, for example, toroidal combustion chamber 110, in particular an annular combustion chamber, with a plurality of coaxially arranged burners 107, a turbine 108 and the exhaust-gas housing 109 follow one another along the rotor 103.

The annular combustion chamber 110 is in communication with a, for example, annular hot-gas passage 111, where, by way of example, four successive turbine stages 112 form the turbine 108.

Each turbine stage 112 is formed, for example, from two blade or vane rings. As seen in the direction of flow of a working medium 113, in the hot-gas passage 111 a row of guide vanes 115 is followed by a row 125 formed from rotor blades 120.

The guide vanes 130 are secured to an inner housing 138 of a stator 143, whereas the rotor blades 120 of a row 125 are fitted to the rotor 103 for example by means of a turbine disk 133.

A generator (not shown) is coupled to the rotor 103.

While the gas turbine 100 is operating, the compressor 105 sucks in air 135 through the intake housing 104 and compresses it. The compressed air provided at the turbine-side end of the compressor 105 is passed to the burners 107, where it is mixed with a fuel. The mix is then burnt in the combustion chamber 110, forming the working medium 113. From there, the working medium 113 flows along the hot-gas passage 111 past the guide vanes 130 and the rotor blades 120. The working medium 113 is expanded at the rotor blades 120, transferring its momentum, so that the rotor blades 120 drive the rotor 103 and the latter in turn drives the generator coupled to it.

While the gas turbine 100 is operating, the components which are exposed to the hot working medium 113 are subject to thermal stresses. The guide vanes 130 and rotor blades 120 of the first turbine stage 112, as seen in the direction of flow of the working medium 113, together with the heat shield elements which line the annular combustion chamber 110, are subject to the highest thermal stresses.

To be able to withstand the temperatures which prevail there, they may be cooled by means of a coolant.

Substrates of the components may likewise have a directional structure, i.e. they are in single-crystal (SX structure) or have only longitudinally oriented grains (DS structure).

By way of example, iron-based, nickel-based or cobalt-based superalloys are used as material for the components, in particular for the turbine blade or vane 120, 130 and components of the combustion chamber 110.

Superalloys of this type are known, for example, from EP 1 204 776 B1, EP 1 306 454, EP 1 319 729 A1, WO 99/67435 or WO 00/44949.

The guide vane 130 has a guide vane root (not shown here), which faces the inner housing 138 of the turbine 108, and a guide vane head which is at the opposite end from the guide vane root. The guide vane head faces the rotor 103 and is fixed to a securing ring 140 of the stator 143.

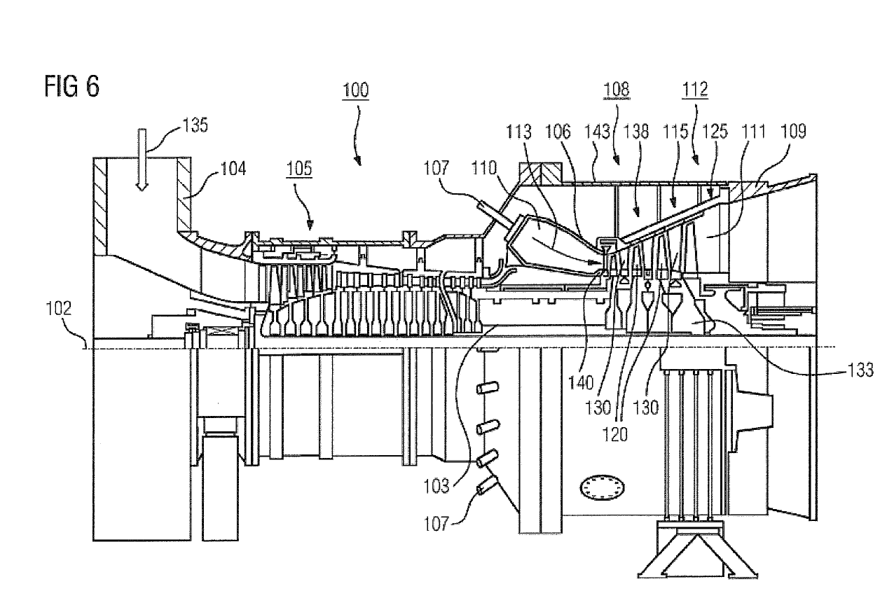

FIG. 7 shows a perspective view of a rotor blade 120 or guide vane 130 of a turbomachine, which extends along a longitudinal axis 121.

The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403 and a main blade or vane part 406 and a blade or vane tip 415.

As a guide vane 130, the vane 130 may have a further platform (not shown) at its vane tip 415.

A blade or vane root 183, which is used to secure the rotor blades 120, 130 to a shaft or a disk (not shown), is fainted in the securing region 400.

The blade or vane root 183 is designed, for example, in hammerhead form. Other configurations, such as a fir-tree or dovetail root, are possible.

The blade or vane 120, 130 has a leading edge 409 and a trailing edge 412 for a medium which flows past the main blade or vane part 406.

In the case of conventional blades or vanes 120, 130, by way of example solid metallic materials, in particular superalloys, are used in all regions 400, 403, 406 of the blade or vane 120, 130.

Superalloys of this type are known, for example, from EP 1 204 776 B1, EP 1 306 454, EP 1 319 729 A1, WO 99/67435 or WO 00/44949.

The blade or vane 120, 130 may in this case be produced by a casting process, by means of directional solidification, by a forging process, by a milling process or combinations thereof.

Workpieces with a single-crystal structure or structures are used as components for machines which, in operation, are exposed to high mechanical, thermal and/or chemical stresses.

Single-crystal workpieces of this type are produced, for example, by directional solidification from the melt. This involves casting processes in which the liquid metallic alloy solidifies to form the single-crystal structure, i.e. the single-crystal workpiece, or solidifies directionally.

In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably forms transverse and longitudinal grain boundaries, which negate the favorable properties of the directionally solidified or single-crystal component.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures).

Processes of this type are known from U.S. Pat. No. 6,024,792 and EP 0 892 090 A1.

The blades or vanes 120, 130 may likewise have coatings protecting against corrosion or oxidation e.g. (MCrAlX; M is at least one element selected from the group consisting of iron (Fe), cobalt (Co), nickel (Ni), X is an active element and stands for yttrium (Y) and/or silicon and/or at least one rare earth element, or hafnium (Hf)). Alloys of this type are known from EP 0 486 489 B1, EP 0 786 017 B1, EP 0 412 397 B1 or EP 1 306 454 A1.

The density is preferably 95% of the theoretical density. A protective aluminum oxide layer (TGO=thermally grown oxide layer) is formed on the MCrAlX layer (as an intermediate layer or as the outermost layer).

The layer preferably has a composition Co-30Ni-28Cr-8Al-0.6Y-0.7Si or Co-28Ni-24Cr-10A1-0.6Y. In addition to these cobalt-based protective coatings, it is also preferable to use nickel-based protective layers, such as Ni-10Cr-12Al-0.6Y-3Re or Ni-12Co-21Cr-11Al-0.4Y-2Re or Ni-25Co-17Cr-10Al-0.4Y-1.5Re.

It is also possible for a thermal barrier coating, which is preferably the outermost layer, to be present on the MCrAlX, consisting for example of ZrO₂, Y₂O₃—ZrO₂, i.e. unstabilized, partially stabilized or fully stabilized by yttrium oxide and/or calcium oxide and/or magnesium oxide.

The thermal barrier coating covers the entire MCrAlX layer. Columnar grains are produced in the thermal barrier coating by suitable coating processes, such as for example electron beam physical vapor deposition (EB-PVD).

Other coating processes are possible, e.g. atmospheric plasma spraying (APS), LPPS, VPS or CVD. The thermal barrier coating may include grains that are porous or have micro-cracks or macro-cracks, in order to improve the resistance to thermal shocks. The thermal barrier coating is therefore preferably more porous than the MCrAlX layer.

The blade or vane 120, 130 may be hollow or solid in form.

If the blade or vane 120, 130 is to be cooled, it is hollow and may also have film-cooling holes 418 (indicated by dashed lines).

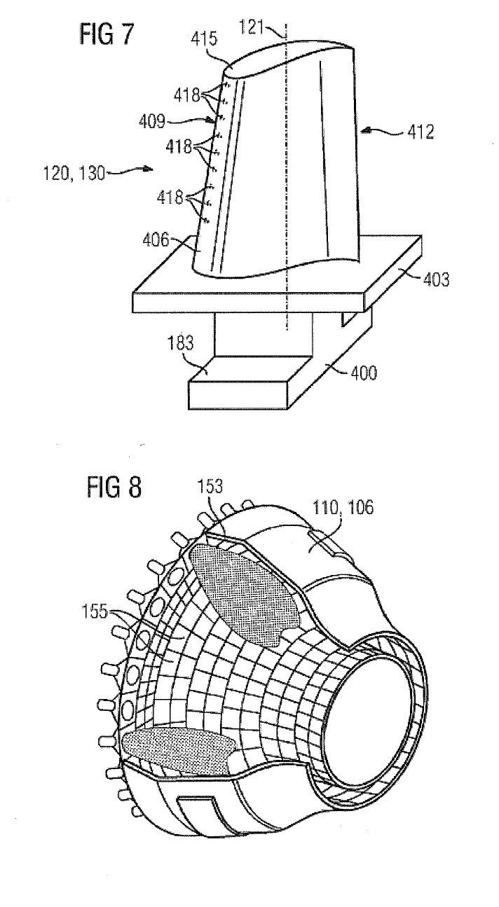

FIG. 8 shows a combustion chamber 110 of the gas turbine 100.

The combustion chamber 110 is configured, for example, as what is known as an annular combustion chamber, in which a multiplicity of burners 107, which generate flames 156, arranged circumferentially around an axis of rotation 102 open out into a common combustion chamber space 154. For this purpose, the combustion chamber 110 overall is of annular configuration positioned around the axis of rotation 102.

To achieve a relatively high efficiency, the combustion chamber 110 is designed for a relatively high temperature of the working medium M of approximately 1000° C. to 1600° C. To allow a relatively long service life even with these operating parameters, which are unfavorable for the materials, the combustion chamber wall 153 is provided, on its side which faces the working medium M, with an inner lining formed from heat shield elements 155.

Moreover, a cooling system may be provided for the heat shield elements 155 and/or their holding elements, on account of the high temperatures in the interior of the combustion chamber 110. The heat shield elements 155 are then, for example, hollow and may also have cooling holes (not shown) opening out into the combustion chamber space 154.

On the working medium side, each heat shield element 155 made from an alloy is equipped with a particularly heat-resistant protective layer (MCrAlX layer and/or ceramic coating) or is made from material that is able to withstand high temperatures (solid ceramic bricks).

These protective layers may be similar to the turbine blades or vanes, i.e. for example MCrAlX: M is at least one element selected from the group consisting of iron (Fe), cobalt (Co), nickel (Ni), X is an active element and stands for yttrium (Y) and/or silicon and/or at least one rare earth element or hafnium (HO. Alloys of this type are known from EP 0 486 489 B1, EP 0 786 017 B1, EP 0 412 397 B1 or EP 1 306 454 A1.

It is also possible for a, for example ceramic, thermal barrier coating to be present on the MCrAlX, consisting for example of ZrO₂, Y₂O₃—ZrO₂, i.e. unstabilized, partially stabilized or fully stabilized by yttrium oxide and/or calcium oxide and/or magnesium oxide.

Columnar grains are produced in the thermal barrier coating by suitable coating processes, such as for example electron beam physical vapor deposition (EB-PVD).

Other coating processes are possible, e.g. atmospheric plasma spraying (APS), LPPS, VPS or CVD. The thermal barrier coating may include grains that are porous or have micro-cracks or macro-cracks, in order to improve the resistance to thermal shocks.

Refurbishment means that after they have been used, protective layers may have to be removed from turbine blades or vanes 120, 130 or heat shield elements 155 (e.g. by sand-blasting). Then, the corrosion and/or oxidation layers and products are removed. If appropriate, cracks in the turbine blade or vane 120, 130 or in the heat shield element 155 are also repaired. This is followed by recoating of the turbine blades or vanes 120, 130 or heat shield elements 155, after which the turbine blades or vanes 120, 130 or the heat shield elements 155 can be reused.

1-6. (canceled)

7. A process for the surface analysis of at least partially closed holes in a component which are to be opened, comprising:
measuring a component comprising the unclosed holes in the uncoated state;
generating a mask model wherein the mask model includes the position of the holes and also the orientation of the longitudinal axes thereof, or the mask model is known in advance from a data record, wherein the first extents of the unclosed holes are thereby known,
coating the component;
measuring the coated component by means of laser triangulation and the at least partially closed holes,
wherein the data record thus generated represents the coating model, and
wherein, in the region of the troughs which were formed by the at least partially closed holes, a plurality of second extents thereof are determined, and
wherein a fit is determined with the first extents over all the holes and the determined second extents in order to make it possible to position and orient and thus detect the closed hole.

8. The process as claimed in claim 7, wherein the mask model is generated by means of laser triangulation measurement.

9. The process as claimed in claim 7, wherein which the mask model is known in advance from the design of the component.

10. The process as claimed in claim 7, wherein the best possible concurrence of the mask model and the coating model is determined by iteration.

11. The process as claimed in claim 7, wherein completely closed holes are detected.

12. The process as claimed in claim 7, wherein partially closed holes are detected.

13. A process for reopening coated holes in a component, comprising:
detecting the position and orientation of the coated holes as detected by the process as claimed in claim 7; and
reopening the holes with a machining program, which has been generated by the comparison between the mask model and the coating model.
